(19) United States
(12) Patent Application Publication
(10) Pub. No.: US 2006/0235086 A1
(43) Pub. Date: Oct. 19, 2006

(54) Ordered colloids

(76) Inventors: Garry R. Maskaly, Los Alamos, NM (US); Yet-Ming Chiang, Framingham, MA (US); W. Craig Carter, Jamaica Plain, MA (US)

Correspondence Address: CHOATE, HALL & STEWART LLP, TWO INTERNATIONAL PLACE, BOSTON, MA, 02110, US

(21) Appl. No.: 11/269,859

(22) Filed: Nov. 7, 2005

Related U.S. Application Data
(60) Provisional application No. 60/626,012, filed on Nov. 7, 2004.

(51) Int. Cl. B01F 3/12; B01F 17/00

(52) U.S. Cl. 516/77

(57) ABSTRACT

Ordered colloids are rapidly formed by dialysis and exhibit unusual levels of shock resistance. Ordered colloids may be used to form a “fingerprint” optical diffraction pattern for security marking, and may also be used for freshness dating by controlling the timing of the formation or loss of order. The ordered colloids may be biocompatible, and may be directly incorporated into foods, drugs, or other ingestible substances, or they may be incorporated into distinctive packaging.

This application claims priority from U.S. Provisional Application No. 60/626,012, filed Nov. 7, 2004, the entire contents of which are incorporated herein by reference.

### FIELD OF THE INVENTION

The present invention relates to methods of forming and using stable ordered colloid solutions.

### BACKGROUND OF THE INVENTION

It has been known since approximately the late 1960s that a suspension of monodisperse, like-charged particles exhibiting electrostatic repulsion from one another can form an ordered array in liquid suspension. The presence of order can typically be detected as iridescence or opalescence or color resulting from diffraction when such diffraction occurs in the visible spectrum of wavelengths. However, the application of such ordered materials has been limited by the difficulty of their preparation. The creation of suspensions that will exhibit such order is often time-consuming and impractical. Ion exchange resins and/or dialysis are then employed to lower the ionic strength.

According to T. Okubo in Langmuir, 10, 1695-1702, 1994, incorporated by reference herein, “From our experiences, the deionization process of suspensions with resins is unexpectedly slow.” In the same publication this author describes a procedure in which various monodisperse polystyrene spheres from Dow Chemical Co. or Sekisui Chemical Co., or monodisperse silica spheres from Nippon Zeon Co., are prepared in order to obtain particle ordering in suspension. Described procedures take approximately three weeks to a month or more to complete. In Colloid Polym. Sci., 278, 571-575, 2000, incorporated by reference, T. Okubo, K. Takezawa, and H. Kimura write that “Generally speaking, the deionization of colloidal suspensions with ion-exchange resins is not fast. In our experience it takes more than 3 or 4 weeks before achieving the completely deionized state for the sample suspensions even when the stock suspensions have been deionized in advance for more than 3 years with resins.” In U.S. Pat. No. 5,266,238 to Haacke, et al., incorporated by reference herein, ordered materials are prepared by filtration and dialysis for a period of two to four weeks. In U.S. Pat. No. 5,854,078 to Asher, et al., incorporated by reference herein, a procedure is described wherein “[a]portion of the colloid suspension was removed and further dialysized for about one week in deionized water. The solution was then diluted about three-fold, and further purified by shaking with ion-exchange resin until all of the impurity ions were removed and the CCA self-assembled.”

A second limitation has been that such ordered arrays in a liquid are often unstable. For instance, according to G. Pan, A. S. Tse, R. Kesavamoorthy and S. A. Asher (J. Am. Chem. Soc., 120, 6518-6524, 1998, incorporated by reference herein), “[a]major drawback of liquid CCAs is that weak shear, gravitational, electrical and thermal forces can disturb the crystalline ordering.” Four previous publications are cited by these authors to support this statement. In U.S. Pat. No. 5,266,238, it is stated “The major deficiency associated with the colloidal arrays disclosed by [U.S. Pat. Nos. 4,627,689 and 4,632,517, incorporated by reference herein] is their fragility. The lattice of the array may be destroyed when subjected to shock, temperature variations and ionic influences. This deficiency renders the arrays useless in filter applications.” According to C. E. Reese and S. A. Asher (J. Colloid and Interface Science, 248, 41-46, 2002, incorporated by reference herein), “[t]he most robust crystalline phases occur when electrostatic interactions are maximized, i.e., at the highest particle charge densities and at the lowest solution ionic strengths.”

### SUMMARY OF THE INVENTION

The present invention provides methods of fabricating ordered colloids (also known as “liquid opals” for their opalescent appearance), and also methods of controlling the morphology of such ordered colloids. Ordered colloids may be rapidly produced by dialysis. Further provided are methods of using ordered colloids as “photonic fingerprints,” as components of freshness dating systems, and as decorative elements, both in ingestible items such as foods and pharmaceuticals, and in packaging, paints, and other consumer items.

In one aspect, the invention is method of preparing ordered colloids. The method includes placing a suspension of particles in a dialysis bag, immersing the dialysis bag in a solution having a selected salt concentration, and allowing the particles to self-assemble into an ordered colloid. The dialysis bag may include cellulose ester. The particles may include a metal, polymer, ceramic, or semiconductor, for example polystyrene or silica. Polystyrene particles may be functionalized with sulfate. The volume fraction of particles may be about 2 percent or less, about 2 to about 8 percent, about 8 percent to about 15 percent, or about 15 percent to about 30 percent.

The solution having a selected salt concentration may be deionized water or have a salt concentration in the range of 10−5 to 10−3 mol/L of NaCl. The particles may have a size between about 1 and about 1000 nm.

In another aspect, the invention is a method of identifying an object. The method includes including associating an ordered colloid solution having a known particle concentration and salt concentration with the object to be identified and measuring an optical diffraction pattern or a diffracted beam from the ordered colloid solution.

The ordered colloid solution may include a plurality of ordered colloids. The diffracted beam may be, but need not be, at a visible wavelength. The method may further include measuring a plurality of diffracted beams from the ordered colloid solution.

In another aspect, the invention is a method of determining the freshness of an item. The method includes including associating a colloidal solution having a known particle concentration and salt concentration with the item and visually monitoring the colloidal solution for changes indicative of a change of order, said change of order being indicative of loss of freshness. The change in order may be development or loss of crystalline order. The method may further include providing a source of ions to the colloidal solution, wherein the ions are provided to the solution at a predetermined rate. The method may further include providing a reservoir in ionic communication with the colloidal solution.

In another aspect, the invention is an ordered colloid solution including a predetermined volume fraction of particles in suspension arranged in a periodic crystalline lattice structure, wherein the ordered colloid is stable for a predetermined period of time at a predetermined temperature.

The solution may have a predetermined ionic strength, and the particles may have a size between about 1 and about 1000 nm. The predetermined period of time may be at least one hour, at least one day, at least one week, at least one month, or at least one year. The solution may be edible. The ordered colloid solution may further include one or more of sugar, gelatin, pectin, poly(ethylene oxide), poly(ethylene glycol), surfactants, fragrances, pigments, waxes, moisturizing agents, coloring agents, flavoring agents, and pharmaceutical agents. In another aspect, the invention is a food product, pharmaceutical product, or cosmetic product including the ordered colloid suspension.

### BRIEF DESCRIPTION OF THE DRAWING

The invention is described with reference to the several figures of the drawing, in which,

FIG. 1 is a series of ordered colloids, illustrating opalescence, diffraction, and a variety of colors produced by varying the particle concentration, FIGS. 1(a) and 1(b) being viewed under incident lighting and FIG. 1(c) being viewed with transmitted light from behind the materials;

FIG. 2 is a series of ordered colloids, illustrating a variety of colors and opacities produced by varying the salt concentration, FIG. 2(a) being viewed under incident lighting, FIG. 2(b) under side lighting from below the image, and FIG. 2(c) with transmitted light from behind the materials; and

FIG. 3 is a diffraction pattern for a “photonic fingerprint.”

### DETAILED DESCRIPTION

We have surprisingly discovered that robust, stable, ordered colloids in liquid suspension can be rapidly produced in time scales of one hour or even shorter, and at high ionic strengths, by a simple dialysis-based purification and assembly process. The procedure is described in Example 1 below, starting with monodisperse polystyrene spheres purchased from Interfacial Dynamics Corporation. The resulting ordered colloids (which we also refer to as “liquid opals,” “spatially ordered colloids,” “ordered suspensions,” “colloidal crystals,” or “dialyzed ordered suspensions”) could be seen to form directly in the cylindrical dialysis tubes during the purification process, and could be readily pipetted or poured into test tubes or vials, or as a fluid droplet onto a surface, without losing their order. They exhibited a much higher viscosity and more rigid rheological characteristics compared to disordered counterparts, indicating thixotropic or shear-thinning properties. Certain of the ordered colloids in a vial could be violently shaken by a vortexer without losing their ordering. Thus they are remarkably stable in contrast with previous such materials.

The ordered colloids may be single crystals, or may be polycrystalline (including textured polycrystalline). Their ordering may be graded, e.g., by settling, gradients in ionic strength, mechanical stress, or applied electric or magnetic fields (in the case of magnetic particles). They may take the forms of a bulk volume, sheet, rod, complex shape, emulsion of particles of the ordered colloid within a non-ordered matrix, or multi-scale ordered colloids wherein particles containing one ordered material themselves are in the form of an ordered colloid. The last of these is achieved, for example, by first forming an ordered colloid in a solid particulate form, including the materials of the invention having a solidified matrix, and then suspending said particles so that they order within another suspension. They may also be in the form of liquid, viscous liquid, gel, cream, emollient, or solid, and may exhibit shear thickening, shear thinning, thixotropic, electrorheological, magnetorheological, or photorheological properties.

Interstices of the ordered particles may be fully or partially occupied by liquid, gas, gel, hydrogel, or solid (e.g., polymers, inorganic compounds, or mixtures thereof), and can be fluorescent, phosphorescent, luminescent, lasing, optically absorbing or transmitting, chemically absorbing, gas absorbing, electronically or ionic or mixed conducting, electronically or ionically insulating, birefringent, magnetic, ferroelectric, and/or ferroic. Particles may be of any shape including but not limited to spherical, ellipsoidal (oblate spheroid), rodlike, platelike, tetrahedral, trigonal, fractional polyhedra (e.g., a tetrahedron open on one side, or one half of an octahedron), curved shells such as half of a sphere or ellipsoid, or microscopic parabolic mirrors.

The particles themselves can be fluorescent, phosphorescent, luminescent, lasing, optically absorbing or transmitting, chemically absorbing, gas absorbing, electronically or ionic or mixed conducting, electronically or ionically insulating, birefringent, magnetic, ferroelectric, ferroic, and may comprise polymer, metal, ceramic, organic, inorganic, biological cells, viruses, bacteria, or other living tissues, hybrids of any of the above. Exemplary semiconductor compositions that may be used in nanoparticles include CdS, CdTe, CdSe, InGaP, GaN, PbSe, PbS, InN, InP, and ZnS. Semiconductor nanoparticles are available from Quantum Dot Corporation and Evident Technologies. Metal and oxide nanoparticles may be obtained from Meliorum Technologies. One skilled in the art will be aware of other commercial sources for nanoparticles. Particles may also be produced using the techniques described, for example, in U.S. Patent Publications Nos. 20050235776, 20050019901, and 20050181000 and PCT Publications Nos. WO 00/17655 and WO 00/17656, the contents of all of which are incorporated herein by reference. Exemplary methods of producing nanoparticles include but are not limited to those described in Cushing, B. L., et al., Chem. Rev. 2004, 104, 3893; Hiramatsu, H., et al., Chem. Mater. 2004, 16, 2509; Jana, N. R., et al., J. Am. Chem. Soc. 2003, 125, 14280; Hyeon, T., et al., J. Am. Chem. Soc. 2001, 123, 12798; Brust, M., et al., Chem. Commun. 1994, 801; Leff, D. V., et al., Langmuir 1996, 12, 4723; Osuna, J., et al., J. Phys. Chem. 1996, 100, 14571; Bardaji, M., et al., New J. Chem. 1997, 21, 1243; Zitoun, D., et al., J. Phys. Chem. B 2003, 107, 6997; Courty, A., et al., Adv. Mater. 2001, 13, 254; Ely, T. O., et al., Chem. Mater. 1999, 11, 526; Stoeva, S., et al., J. Am. Chem. Soc. 2002, 124, 2305; O'Brien, S., et al., J. Am. Chem. Soc. 2001, 123, 12085; Caruntu, D., et al., Inorg. Chem. 2002, 41, 6137; Sun, S., et al., J. Am. Chem. Soc. 2002, 124, 8204; Rockenberger, J., et al., J. Am. Chem. Soc. 1999, 121, 11595; Rosetti, R., et al., J. Chem. Phys. 1985, 83; Dannhauser, T., et al., J. Phys. Chem. 1953, 57, 670; Trindade, T., et al., Chem. Mater. 2001, 13, 3843; Stuczynski, S. M., et al., Inorg. Chem. 1989, 28, 4431; Lu, Y., et al., Nano Lett. 2005, 5, 5; Miles, D. T., et al., Anal. Chem. 2003, 75, 1251; Chen, S., et al., J. Am. Chem. Soc. 2001, 123, 10607; Puddephat, R. J. The Chemistry of Gold; Elsevier: Amsterdam, 1978; Laguna, A. In Metal Clusters in Chemistry; Braunstein, P., Oro, L., Raithby, P. R., Eds; Wiley-VCH: Weinheim, 1999; Nanoparticles and Nanostructured Films; Fendler, J. H., Ed.; Wiley-VCH: Weinheim, 1998; Schmid, G., et al., Chem. Ber. 1981, 114, 3634; Hasan, M., et al., J. Am. Chem. Soc. 2003, 125, 1132; Brown, L. O., et al., J. Phys. Chem. B 2001, 105, 8911-8916; Li, W., et al., Colloids Surf 2000, 175, 217; Kanehara, M., et al., J. Am. Chem. Soc. 2003, 125, 8708; Sarathy, K. V., et al., Chem. Commun. 1997, 537, all of which are incorporated herein by reference. Where a particle does not have the optimal charge to be used in embodiments of the invention, one skilled in the art will recognize that a capping layer on the particle may be changed to adjust the surface charge.

The particles may take on any size, e.g., between 1 and 1000 nm. For example, the particles may be between about and about 10 nm, between about 10 and about 100 nm, between about 100 and about 500 nm, or between about 500 and about 1000 nm. The optimal size of the particles will also depend on the volume fraction, solution refraction index, and particle refraction index, all of which may be adjusted to get reflectances of a particular wavelength according to the equation

$${λ}_{111} = \frac{4}{\sqrt{3}} \sqrt[3]{\frac{2 π}{3}} \frac{r}{\sqrt[3]{{V}_{F}}} \sqrt{{n}_{solution}^{2} + {V}_{F} ( {n}_{particles}^{2} - {n}_{solution}^{2} )}$$

in which r is the radius, V_{F} is the volume fraction, n corresponds to the refractive indices, and λ₁₁₁ is the reflection wavelength. For example, a suspension with 8 volume percent of 50 nm particles (in radius) exhibits a reflection is at 532 nm. For a 75 nm particle, a 30% volume fraction is required to get the same reflection. However, reflectances in the IR can still be obtained with larger particles, which may be useful for labeling applications, since potential counterfeiters will not be able to detect the colloid without mechanical assistance. For example, a colloidal suspension of 200 nm radii particles at 8 volume percent will reflect at 2.1 microns. This isn't visible to the eye, but is easily detectable.

The particles may be present in suspension in any concentration. As discussed above, the optimal concentration will depend in part on the desired reflection wavelength. In addition, as the concentration becomes too low, the interaction between particles may become weaker. As the concentration increases, the suspension may become too viscous for the particles to move around and order. However, the concentration will depend on the particle size. In some embodiments, the concentration is between about 2 and about 8 volume percent, but the concentration may be less, for example, between about 1 and about 2 volume percent, or greater, for example, between about 8 and about 15 volume percent, or between about 15 and about 30 volume percent, or greater than 30 volume percent. In some embodiments, any concentration less than the percolation threshold for the particle may be used.

The ordered colloids may also include combinations of particles, including but not limited to a bimodal or multimodel combination of particles of controlled size ratio, number ratio, charge or surface potential ratio, continuous distributions of size in a single shape, or distribution of shapes. These order in a variety of structures not possible with colloids consisting of a single narrow particle size distribution. One example is the zincblende structure, comprising two particle types of a size ratio defined by crystal chemical considerations, and provided in approximately 1:1 number ratio. Such a structure has a complete or nearly complete photonic bandgap. Variation in particle size changes the total charge on the particles for a given surface charge density. As a result, multimodal particle size distributions can be used to create higher order complexity in ordered structures.

The ordered particle arrays can be combined with a guiding surface or structure that induces local ordering or symmetry in the ordered array.

Properties that may be adjusted include type of order or density or periodicity, photonic crystal properties, index of refraction (including negative index of refraction), symmetry of refraction, photonic bandgap structure, conductivity, crystallite size, opacity, color, permittivity, permeability to fluids, viscosity, magnetic permeability and hysteresis, and photocapacitive properties. The colloids may be manipulated by application of a field, including but not limited to gravitational, electric, magnetic, thermal, chemical, electromagnetic, electrochemical fields, or by electrodialysis, or electrically induced ion concentration changes (e.g., that change the ordering or spacing of ordered particles and could be used as filters, displays). Multi-stable ordering, such as a bi-stable display or multi-directionally stable ordering, is also possible.

Ordered colloids may be produced by controlled solute removal including dialysis, electrodialysis, ion-exchange resins, and any combination of such methods. Dialysis or electrodialysis can be carried out to change salt concentration, add/remove surfactants, or to add/remove functional dilute additives such as laser dyes or other optically active molecules or nanoparticles. Osmosis may be used to add or remove a solvent, e.g., to increase concentration of particles by extraction of water into an alcohol, or to change the dielectric constant of the solvent. Particles may be concentrated by centrifugation or by evaporation of the liquid (which may also be used to increase the ionic strength). Controlled titration of pH can change the sign and magnitude of surface charge.

Salt concentration may be diluted by direct addition of solvent (as distinct from osmotic addition of solvent). The dielectric constant may be titrated by osmosis or evaporation or direct addition of another component. Absorption of moisture from air, in the case of a nonaqueous or partially nonaqueous medium, may also change the solution chemistry (including pH), as may absorption of CO₂ from air. Application of a field may induce or assist or alter ordering.

The ordered colloids may be used in a variety of ways. For example, a colloidal crystal has a unique optical diffraction “fingerprint” that may be used to identify an object with which it is associated. The colloidal crystal may be engineered to remain stable for a known period of time, as discussed further below, in order to act as a freshness marker. The combination of opalescent appearance and non-toxicity offers the possibility that the ordered colloids may be used decoratively or as characteristic markers in foods, drugs, and the like. The opalescent appearance and unique “fingerprint” may render the ordered colloids useful in decorative and/or security paints.

Near a critical salt concentration or particle concentration, the opalescence is more easily disturbed or the color changed if the colloid is shaken or undergoes mechanical shock. Rheology may also change upon disordering. These properties may be used in motion and vibration detectors. The ordered colloids may also be used for touch-screen applications, where actuation can be sensed by having a colloidal crystal that is near the percolation limit and changes conductivity or capacitance with deformation, or below the percolation limit and that changes capacitance with pressure. In similar embodiments, the ordered colloids may be used in a pressure sensing medium (e.g., elastochromic, piezochromic, or barochromic), or may be used for inkless fingerprinting. Ordering and/or properties may also be dynamically changed by applied electric fields (e.g., to change the ion concentration of the medium in which ordering occurs), for use in displays, reflectors, filters, and/or windows.

The ordered colloids may provide a lasing medium for lasers, tunable lasers, and/or large area/volume lasers, or may provide other unique optical components such as negative refractive index materials and devices (e.g., for sub-diffraction limit lenses), perfectly diffracting mirrors, or a perfect one-way mirror (e.g., a colloid of ordered mirror particles, such as spherical shell or parabolic, that reflect light from one direction only).

### EXAMPLES

### Example 1

### Formation of Ordered Colloids

We have found that rapid formation of the ordered colloids by dialysis alone can be achieved with certain types of dialysis materials. It is desirable to have a membrane which has sufficiently small pore size to contain the colloidal particles in question, while allowing a maximum ion-exchange rate with the purifying solution. The cross-sectional size and shape of the dialyzed volume is also a factor in achieving rapid ordering via dialysis.

For example, commercially available Spectra/Por Float-A-Lyzer™ dialysis bags made of biotech cellulose ester membranes, packaged in 0.1% sodium azide preservative, were successfully used with sulfate-functionalized polystyrene particles from Interfacial Dynamics Corporation. We successfully used dialysis bags of 50, 100, and 300 kiloDalton molecular weight cutoff (MWCO). Although bags having MWCO below 50 kD may also be successful, they were not used since they would increase the dialysis time. In contrast, above a certain kiloDalton MWCO, the colloidal particles of interest may pass through the membrane. The bag length was 10 cm in all cases, while the diameter ranged from 0.5 cm to 1 cm depending on the bag volume, which was typically 5 to 10 mL. The bags floated in the dialysis solution and remained upright, and had a circular cross-section.

In contrast, another type of dialysis membrane produced by the same manufacturer, Spectra/Por Biotech Dialysis Membranes PVDF, also packed in 0.1% sodium azide, did not provide for rapic colloidal ordering. These dialysis membrane tubes come supplied as a long roll (˜10 m), that must be cut to length and closed, for example with a mechanical closure or heat sealing, which can also change the geometry of the bag compared to the cylindrical shape of the Float-A-Lyzer™ bags. The diameter was 1 cm and the MWCO is 250 kiloDaltons.

The particles tested were sulfate functionalized polystyrene particles from Interfacial Dynamics Corporation. The particle diameters tested were in the 113 nm to 215 nm range and all were successfully ordered via dialysis; particles outside this range are also expected to be ordered with appropriate control of experimental parameters, as will be apparent to those of ordinary skill in the art. As-received, the particle concentrations were 8 volume percent, and were dispersed in water. The particle concentrations were dialysed to several concentrations between 2 and 8 volume percent, all of which were possible to order via dialysis. Thus it is seen that the concentration of particles, and the associated materials cost of providing a final ordered colloidal product, can be exceptionally low.

To carry out colloidal ordering by dialysis, a 5 mL to 10 mL volume of the particle suspension, either in the as-received volume concentration or diluted with deionized water to a lower concentration, was placed in the dialysis bag. The dialysis bag was then placed in a polypropylene container containing either 1 liter or 500 mL of deionized water alone, or, in experiments to characterize the effect of salt concentration on colloidal ordering, a known concentration of NaCl in deionized water. To prepare these solutions, a measured mass of the NaCl was first added to deionized (DI) water to make a 10⁻²M solution. This solution was then diluted to lower concentrations with DI water. The dialysis bag containing the colloidal suspension was then placed in the salt solution. To ensure that the interior volume of the dialysis bag reached the same salt concentration as the solution, up to 3 exchanges of the solution (exterior to the dialysis bag) were performed over a period of 24 hours.

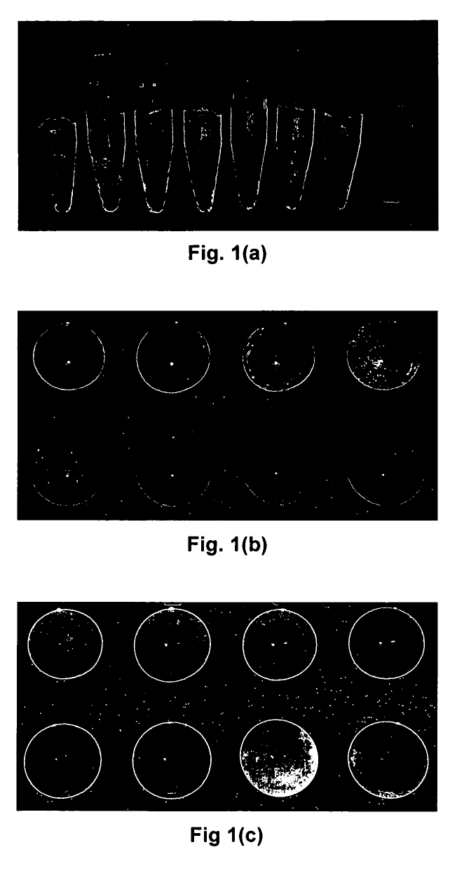

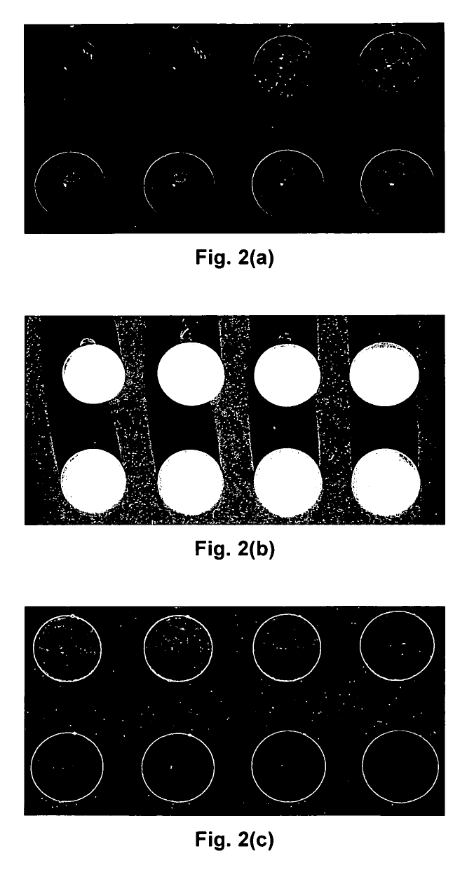

Using deionized water alone outside of the dialysed volume, the particle suspension exhibited visual appearance characteristic of colloidal particle ordering that was largely complete within one hour in the case of an 8 volume percent suspension, and within a few hours at particle concentrations as dilute as 2 volume percent. This is a remarkably short time compared to previous descriptions of this phenomenon in the patent or journal literature. All particle concentrations between 2 and 8 volume percent exhibited ordering. The visual characteristics indicating colloidal ordering were opalescence, decrease in turbidity and increase in light transmission, and diffracting regions showing presence of ordered “crystallites,” as seen in FIGS. 1 and 2.

FIG. 1 shows a series of these ordered colloids having varying particle volume fractions. As the particles are diluted, the color shifts from blue-green toward red. All of the samples shown here formed within a few hours of dialysis against deionized water. The particle concentrations from top left to bottom right are 8.1%, 7.3%, 6.5%, 5.7%, 4.9%, 4.1%, 3.2%, and 2.0%. In transmitted light, shown in FIG. 1(c), colors not reflected by the ordered structure become apparent.

FIG. 2 shows a series of these ordered colloids having varying salt concentrations. Previously, crystallization has only been observed at very low ionic strengths. Here we show ordering with as much salt as 1.5 10⁻⁴ mol/L. From top left to bottom right, the salt concentrations are 1.0×10⁻⁵, 1.0×10⁻⁴, 1.5×10⁻⁴, 1.75×10⁻⁴, 2.0×10⁻⁴, 2.5×10⁻⁴, 5.0×10⁻⁴, and 1.0×10⁻³ mol/L of NaCl. Note that near the transitional ionic strength the crystallite size becomes larger with individual grains being visible to the naked eye. The crystals in FIGS. 1 and 2 are stable against many mechanical disturbances with the exception of violent shaking, where air bubbles pass through the crystal, and ultrasonication. In a tightly packaged container, it is difficult to destroy the crystalline order.

Larger crystallites or “grains” were observed at salt concentrations near a limiting concentration above which disorder occurs, as shown in FIG. 2. This limiting concentration can be thought of as a “melting” salt concentration. Even in solutions containing salt concentrations up to this limiting concentration, colloidal ordering could be observed within 24 hours. From FIG. 1, it is also clear that even lower concentrations below 1 volume percent can be ordered to provide strong photonic effects given somewhat longer but still practical dialysis times.

In contrast to the above cases that ordered rapid ordering, the PVDF dialysis membrane exhibited no visually detectable colloidal ordering even at the highest particle concentrations and lowest salt concentrations even after 24 hours of dialysis.

The ordered colloidal suspensions were readily removed from the dialysis bags by pouring into vials as shown in FIG. 1, or pipetting the suspension and placing on surfaces as shown in FIG. 2, or even deliberate agitation by shaking, without losing the visually observed ordering. Thus these ordered colloids, even in the absence of stabilizing additives that cause gelling or polymerization or increased viscosity of the aqueous matrix, are seen to be highly stable in contrast to previous such materials described in the literature.

### Example 2

### Photonic Fingerprinting

This example describes a general approach to authenticating products using ordered colloids, whether they are of the type described in this patent application or of any other type, including for example compacted ordered colloids such as synthetic opals formed from narrow dispersity particle suspensions by settling, drying, or other methods well-known to those skilled in the art, or the “ionic colloidal crystals” described in our U.S. patent application Ser. No. 10/424,672, incorporated by reference herein.

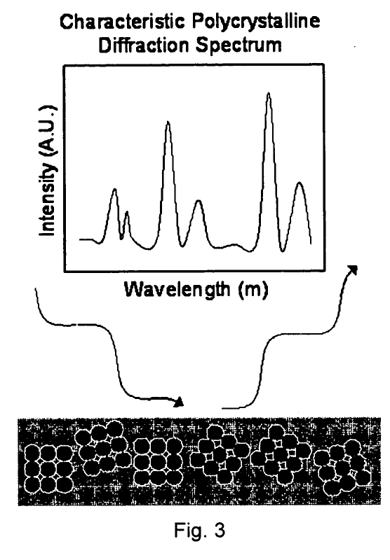

An ordered colloid exhibits an optical diffraction pattern, schematized in FIG. 3, that is a unique fingerprint of the colloidal crystalline structure. The diffraction pattern is characterized by several features, including the diffraction angle at which specific reflections occur, the intensity of the diffraction peaks relative to one another, and the breadth of the peaks (which may be influenced by colloid structure as well as instrument factors in the reading of the diffraction pattern). These features are uniquely characteristic of several aspects of the ordered colloid. They firstly are characteristic of the structure of the ordered colloid and whether it is single crystalline or polycrystalline. With single-component colloids, the accessible structures are generally face-centered-cubic or body-centered-cubic and typically generate 10 to 20 distinct reflections within the instrumental range of available diffractometers, while a much wider range of structures are accessible with multicomponent colloids, as described in U.S. patent application Ser. No. 10/424,672. Secondly, for any given structure type the diffraction angles at which reflections occur are a highly sensitive measure of the periodic dimensions of the crystalline array, which may be determined by particle size or by volume concentration of particles. For the ordered colloids described in Example 1, the wavelength range of diffraction can range from the UV to near IR, and therefore include wavelengths that are “invisible” as well as visible. Thirdly, for multicomponent colloidal crystals, the relative intensity of diffraction peaks is also determined by the relative scattering power of the particles, and can be varied by changing particle density, for example. Thus a single colloidal crystalline material has a highly specific diffraction pattern that is virtually impossible to duplicate except by having an identical material.

Additional degrees of freedom can be added to provide a diffraction pattern that is even more difficult to duplicate, by combining different colloidal crystals each of which has its own unique diffraction pattern. This approach is analogous to the X-ray or electron diffraction of multiphase crystalline materials. The observed diffraction pattern from a multiphase crystalline material is the superposition of the diffraction patterns of each, and enormous complexity and uniqueness can be generated by combining different materials. The features of the multiphase diffraction pattern, such as the diffraction angles and relative intensities of peaks, depend on the relative amount (percentage) of each material as well as the diffraction pattern specific to each material. Thus it is seen that by combining a number of colloidal crystals, each of which has its own diffraction pattern, a unique diffraction pattern can be produced that is extremely difficult to reproduce with any other material or approach.

The “fingerprinting” or “anti-counterfeiting” or “authentication” method of this Example utilizes one or more colloidal crystal materials contained within, e.g., a label on a product (including applied labels or tape, for example), the packaging around the product (including the outer shell of a consumer electronic device, or shipping tape used to wrap a product, or wrapping paper, for example), or within the product itself (including colloidal crystals suspended in a liquid or gel or solid product, for example). The diffraction pattern of this tag may then be read or scanned with a spectrometer. The combination of a material providing a unique fingerprint with a spectrometer reading its diffraction pattern is one aspect of the invention. Other aspects of the invention include specific forms of the photonic labels such as labels, tape, and exterior packaging, the embedding of a photonic label within a product, such as within the plastic shell of a consumer electronic product or the gelatin capsule containing a pharmaceutical or dispersed in a high added-value alcoholic beverage, cosmetic or perfume, or liquid pharmaceutical. The spectrometer may be of a type that can detect with sufficient angular resolution to distinguish individual reflections over a wide range of diffraction angles under fixed wavelength illumination, or one which can illuminate with multiple wavelengths and detect at a fixed angle. More limited spectrometer capabilities, such as the measurement of one or two specific reflections, can also be usefully applied. The design and construction of such spectrometers are well-known to those skilled in the art. Note that the methods of this Example include both invisible photonic fingerprints that are only read when desired as well as visible anticounterfeiting and authentication to serve attraction or deterrence purposes.

### Example 3

### Freshness-Dating Approach and Devices Utilizing Ordered Colloids

The unique visual appearance, dramatic changes in transparency, and responsiveness of colloidal ordering to the ionic strength of the suspension allows ordered colloidal materials to be used as the basis for freshness-dating devices for a broad range of products. These products can be food items that have a spoilage time depending on temperature from hours to weeks (e.g., dairy products, vegetables, prepared foods) to months (e.g., dry goods, canned goods, pasteurized and sealed foods). They can be vaccines that must be refrigerated and have a spoilage time similar to food items, or pharmaceuticals with expiration dates of months to years. In fact, the time-since-manufacturing of virtually any product that has a limited shelf life can measured and displayed using the approach of this example.

The materials and devices of this example may be exploited to track: 1) the passage of time at a relatively constant temperature, such as the elapsed time of a product at a relatively constant refrigeration temperature; 2) extremes in temperature excursions at any time since packaging, such as when a product is overheated, even briefly; or 3) the integrated effects of time and temperature, this being important for example in the case of products that spoil more slowly at elevated temperature than at lower temperature.

Displays of freshness may be based on at least three modes of visual change. The simplest is the appearance or disappearance of the opalescent, diffractive, or transparent/translucent appearance of a volume of a suspension containing colloidal particles within which the ionic strength changes over time. A second mode employs a volume or a film of colloidal suspension that is initially ordered and thereby has high optical transmission in the visible wavelength range. The suspension provides a transmissive window through which an underlying text (e.g., reading “fresh”) or graphic can be read when the product is fresh. As the colloidal suspension is induced to disorder over time, e.g., through an increase in ionic strength, the window becomes opaque (in the opaque state, the color can be white or many other colors through the use of dyes in the matrix or the particles) and obscures the underlying text or graphic. A third mode employs a volume or a film of colloidal suspension that is initially disordered, but becomes ordered, e.g., transmissive, with the passage of time at a particular temperature or temperatures. In this mode, an underlying text (e.g., reading “expired”) or graphic becomes visible in order to warn the viewer that the product shelf-life has been exceeded.

In each of the above modes, the colloidal suspension may be an aqueous suspension including salt or may have a modified matrix (the matrix here being defined as the medium surrounding the particles) that contains a gelling, polymerizing, or viscosity-raising or viscosity-thinning additive. For instance, viscosity-raising non-ionic additives can further stabilize an ordered colloid against mechanical shock, and can beneficially affect the rate of ordering or disordering by influencing particle dynamics (mobility) within the suspension or the rate of salt ion transfer into or out of the matrix. For the first two above modes, the desired increase in ionic strength can be accomplished by any of several methods. A salt can be time- and temperature-released into the matrix of the suspension through diffusion and/or dissolution from a source. The source may be the ordering particles themselves, into which a salt was previously introduced, or an adjacent piece of salt-releasing material in the form of particles or a film that dopes the suspension with salt over time. Alternatively or in addition, the particles themselves may dissolve. For example, an ordered colloid of silica particles may dissolve over time, increasing the ionic strength of the suspension and gradually causing the ordered colloid to disorder. Such a salt-releasing material may be an organic or inorganic compound or a composite. Another salt source can be a separate material, solid or liquid or gel, separated from the colloidal suspension by a selectively permeable membrane, including but not limited to the dialysis membranes described herein. The time required to disorder the colloidal solution is also dependent on the particle concentration within the suspension, since that determines the mean spacing of the particles and the specific salt concentration at which disorder occurs (see FIG. 2). The selection of a suitable suspension and salt-releasing materials and the design of physical configurations that provide the desired time and temperature response are readily accomplished through a course of experimental study well-known to those skilled in the art. Yet another method of increasing the salt concentration over time is exposure of the colloid to external gaseous materials that increase the ionic strength of the suspension. One specific example is the dissolution of ambient CO₂; as CO₂ dissolves into water, the ionic strength increases. This increases the electrostatic shielding, which causes the material to become disordered. In general, it may be expected that as ionic strength increases, the particles will gain mobility and may initially show improved order. Large, easily observable grains could signify a nearly expired material. Eventually, complete disorder would show that the product has completely expired.

As a test of these methods, we stored vials of colloidal crystals similar to those in FIG. 1 in ambient air and normal room temperatures, and observed that each of the ordered colloids eventually disordered, in a sequence whereby the crystals of lowest volume fraction particles (largest interparticle separation) disordered first, and the highest volume fractions disordered last. This demonstrated a systematic increase in ionic strength over time causing disorder. In a sealed vial with little or no interior air, an initially ordered material disorders over the period of a few months. This can be due to the leaching of salts from the plastic vial, or can be due to the dissolution of CO₂ into the suspension. It is clear that a carefully designed container material that provides controlled leaching or controlled exposure to air, or a membrane exposed to a higher ionic strength reservoir, could be used to control the time evolution of salt concentration.

In the third of the above modes, the desired decrease in salt concentration over time can be accomplished by various methods. One is to provide a dialysis membrane and reservoir into which the salt is gettered over time, as in the above-described ordering experiments. Another is to supply an ion exchange resin that may be embedded in the particles themselves in the form of separate particles within the suspension, or an adjacent particulate or solid film that over time causes ordering in the colloid.

### Example 4

### Photonic Food and Pharmaceuticals

The attractive, vivid appearance of the subject colloidal crystals (FIGS. 1 and 2), combined with the non-toxic nature of the materials (a low concentration of, e.g., polystyrene particles, water, and optionally a minute amount of salt) lend themselves to edible products of unique appearance. For example, photonic candy having opal-like or diffractive effects can be readily produced by adding non-ionic or low-ionic strength constituents such as sugars, flavoring agents, food-approved coloring agents, gelatin, pectin, polyethylene oxide (PEO), polyethylene glycol (PEG), etc. to the formulation of an ordered colloidal suspension. The suspension is allowed to order while the liquid is in a low viscosity state, for example at elevated temperature or prior to gelation or polymerization, following which cooling or gelation is allowed to occur to preserve the colloidal crystal structure.

Another form of photonic food includes fluids with a “liquid opal” appearance, such as drinks and sauces. This product is similar to photonic candy except that the colloidal crystal suspension remains fluid. It may however have gel-like shear-thinning or thixotropic properties as an added feature. Other consumable applications include liquid or gel form pharmaceuticals. Appropriate pharmaceutical agents may be identified by reference to “Pharmaceutical Substances: Syntheses, Patents, Applications” by Axel Kleemann and Jurgen Engel, Thieme Medical Publishing, 1999; the “Merck Index: An Encyclopedia of Chemicals, Drugs, and Biologicals”, Edited by Susan Budavari et al., CRC Press, 1996, and the United States Pharmacopeia-25/National Formulary-20, published by the United States Pharmcopeial Convention, Inc., Rockville Md., 2001, all of which are incorporated herein by reference. In addition, the ordered colloids may be used in drug delivery devices, e.g., a color-indicating transdermal delivery device.

### Example 5

### Distinctive Packaging

The visual appearance of the subject ordered colloids is difficult to duplicate by other means. Consequently, they are attractive in a preserved or solid state as packaging materials for products that are vulnerable to counterfeiting. A specific example is pharmaceutical packaging, wherein a gelatin capsule containing ordered colloids (see also photonic candy in Example 4), or an ordered colloid coating on pills, is used to provide a highly distinctive visual appearance. This appearance can naturally be combined with anti-counterfeiting or authentication functions as described in Example 2.

### Example 6

### Photonic Shampoo, Cosmetics, and Other Personal Consumer Products

These embodiments of the invention provide an attractive appearance as in the Examples of photonic foods and packaging, and are produced by like methods. For example, the ordered colloids may be combined with pigments and waxes or powders to form cosmetic products or with moisturizing agents or surfactants to produce lotions. In addition, they may simultaneously be fingerprinted as in Example 2 for authentication purposes. In addition to cosmetics and the like, the decorative properties of the ordered colloids may be used in decorative paints and objects, and in toys (e.g., a liquid opal lava lamp). For example, surfactants, coloring agents, pigments, or fragrances may be added to the colloid.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. A method of preparing ordered colloids, comprising:
placing a suspension of particles in a dialysis bag;
immersing the dialysis bag in a solution having a selected salt concentration; and
allowing the particles to self-assemble into an ordered colloid.

2. The method of claim 1, wherein the dialysis bag comprises cellulose ester.

3. The method of claim 1, wherein the particles comprise a metal, polymer, ceramic, or semiconductor.

4. The method of claim 3, wherein the particles comprise polystyrene or silica.

5. The method of claim 4, wherein the polystyrene is functionalized with sulfate.

6. The method of claim 1, wherein the suspension of particles contains a volume fraction of particles of about 2 percent or less.

7. The method of claim 1, wherein the suspension of particles contains a volume fraction of particles in the range of about 2 to about 8 percent.

8. The method of claim 1, wherein the suspension of particles contains a volume fraction of particles in the range of about 8 percent to about 15 percent.

9. The method of claim 1, wherein the suspension of particles contains a volume fraction of particles in the range of about 15 percent to about 30 percent.

10. The method of claim 1, wherein the solution having a selected salt concentration is deionized water.

11. The method of claim 1, wherein the solution has a salt concentration in the range of 10⁻⁵ to 10⁻³ mol/L of NaCl.

12. The method of claim 1, wherein the particles have a size between about 1 and about 1000 nm.

13. A method of identifying an object, comprising:
associating with the object to be identified an ordered colloid solution having a known particle concentration and salt concentration; and
measuring an optical diffraction pattern or a diffracted beam from the ordered colloid solution.

14. The method of claim 13, wherein the ordered colloid solution comprises a plurality of ordered colloids.

15. The method of claim 13, wherein the diffracted beam is not at a visible wavelength.

16. The method of claim 13, further comprising measuring a plurality of diffracted beams from the ordered colloid solution.

17. A method of determining the freshness of an item, comprising:
associating a colloidal solution having a known particle concentration and salt concentration with the item; and
visually monitoring the colloidal solution for changes indicative of a change of order, said change of order being indicative of loss of freshness.

18. The method of claim 17, wherein the change of order is a loss of order.

19. The method of claim 17, wherein the change of order is development of crystalline order.

20. The method of claim 17, further comprising providing a source of ions to the colloidal solution, wherein the ions are provided to the solution at a predetermined rate.

21. The method of claim 17, further comprising providing a reservoir in ionic communication with the colloidal solution, wherein the reservoir getters ions from the colloidal solution.

22. An ordered colloid solution, comprising a predetermined volume fraction of particles in colloidal solution arranged in a periodic crystalline lattice structure, wherein the ordered colloid is stable for a predetermined period of time at a predetermined temperature.

23. The ordered colloid suspension of claim 22, wherein the particles comprise a metal, polymer, ceramic, or semiconductor.

24. The ordered colloid solution of claim 23, wherein the particles comprise polystyrene or silica.

25. The ordered colloid solution of claim 24, wherein the polystyrene is functionalized with sulfate.

26. The ordered colloid solution of claim 22, wherein the solution of particles contains a volume fraction of particles of about 2 percent or less.

27. The ordered colloid solution of claim 22, wherein the solution of particles contains a volume fraction of particles in the range of about 2 to about 8 percent.

28. The ordered colloid solution of claim 22, wherein the solution of particles contains a volume fraction of particles in the range of about 8 percent to about 15 percent.

29. The ordered colloid solution of claim 22, wherein the solution of particles contains a volume fraction of particles in the range of about 15 percent to about 30 percent.

30. The ordered colloid solution of claim 22, wherein the solution has a predetermined ionic strength.

31. The ordered colloid solution of claim 22, wherein the particles have a size between about 1 and about 1000 nm.

32. The ordered colloid solution of claim 22, wherein the predetermined period of time is at least one hour.

33. The ordered colloid solution of claim 22, wherein the predetermined period of time is at least one day.

34. The ordered colloid solution of claim 22, wherein the predetermined period of time is at least one week.

35. The ordered colloid solution of claim 22, wherein the predetermined period of time is at least one month.

36. The ordered colloid solution of claim 22, wherein the predetermined period of time is at least one year.

37. The ordered colloid solution of claim 22, wherein the solution is edible.

38. The ordered colloid solution of claim 22, further comprising one or more of sugar, gelatin, pectin, poly(ethylene oxide), poly(ethylene glycol), surfactants, fragrances, pigments, waxes, moisturizing agents, coloring agents, flavoring agents, and pharmaceutical agents.

39. A food product comprising the ordered colloid solution of claim 22.

40. A pharmaceutical product comprising the ordered colloid solution of claim 22.

41. A cosmetic product comprising the ordered colloid solution of claim 22.
